(19) United States
(12) Patent Application Publication
(10) Pub. No.: US 2010/0055430 A1
(43) Pub. Date: Mar. 4, 2010

(54) Planar sheet vapor barrier

(76) Inventors: Timothy Wilkerson, Braidwood, IL (US); Louis F. Cole, Plainfield, IL (US)

Correspondence Address: Charles F. Lind, 2210 E. Sherwood Road, Arlington Hts., IL, 60004, US

(21) Appl. No.: 12/229,618

(22) Filed: Aug. 26, 2008

(51) Int. Cl. B32B 7/02; B32B 3/26

(52) U.S. Cl. 428/215; 428/319.1

(57) ABSTRACT

The disclosed planar vapor barrier is comprised of three thin planar sheets sandwiched fixedly together. One outer sheet is of aluminum foil, with a very thin reinforcing film of polyethylene on its outer face. The other outer sheet is of plastic, preferably with embedded reinforcing filaments. The middle sheet is of a foamed plastic. The outer sheets can have generally similar thicknesses, while the middle sheet can be significantly thicker. The entire planar vapor barrier can between 0.01″-0.05″ thick. The planar vapor barrier is durable and tough, and most effective when spread over a dirt crawl space floor for blocking ground vapors from entering the building. To cover larger areas, several different planar barriers can be laid out to overlap at adjacent edges, whereby tape can secure the adjacent edges together.

### BACKGROUND OF THE INVENTION

Buildings have peripheral side walls supporting roof structures that define interior enclosures. Lower areas, such as crawl spaces, frequently might have only dirt and/or dirt/stone floors. Gases including water vapor and the potentially toxic radioactive Radon gas might then be discharged via the unsealed crawl space floors into the building enclosure. This can be unhealthy and/or uncomfortable to the building occupants.

Recognizing this, it is common to spread a thin vapor barrier, such as a plastic sheet, over the dirt crawl spaces floor so as to restrict free passage of these gases. However, many existing plastic barrier sheets are either so thin to easily puncture or rip or so thick to be heavy and difficult to be properly positioned.

### OBJECTS AND FEATURES OF THE INVENTION

This invention relates to an improved composite planar sheet vapor barrier suited for preventing the passage of gases there through.

The improved composite planar sheet barrier is sufficiently light weight to be spread out flat at many building locations, but yet tough, durable and highly resistant to the transverse passage of water vapor or other gases, for improved thermal, moisture and draft control and personal comfort.

The improved composite planar sheet barrier can be formed of three generally planar sheet-like components overlaid and secured together. It is durable and resistant against punctures and tears, can be offered in convenient sizes (possibly 6 to 12 feet wide) and stored on rolls to allow easy layout over a floor or the like, and can be sufficiently light for easy installation in being laid out flat with adjacent edges overlapped and tapped together, suited even for broad area coverage if needed.

### SUMMARY OF THE INVENTION

The inventive planar barrier might be formed of three different generally planar sheet components overlaid and secured together. Lamination under heat and pressure is a preferred manner of securing the components together in forming the composite vapor barrier sheet. Adhesive could also or alternatively be interposed between the adjacent planar components.

One main use of this barrier might be to spread it out over a crawl space dirt floor, possibly even having its edges rise up and overlie the lower inch or so of the foundation wall. The edges of the different composite sheets could be overlapped and taped together, and tape could also secure the sheet edges to the adjacent foundation wall.

### BRIEF DESCRIPTION OF THE DRAWINGS

These and other objects, features or advantages of the invention will be more fully understood and appreciated after considering the following description of the invention, which includes the accompanying drawings, wherein:

FIG. 1 is an enlarged sectional view of the improved composite vapor barrier sheet formed according to the invention;

FIG. 2 is a facial view of the vapor barrier sheet;

FIG. 3 is a section view of several barrier sheets laid out over a crawl space floor and up the foundation wall, with adjacent edges overlapped and taped, to form the sealed vapor barrier.

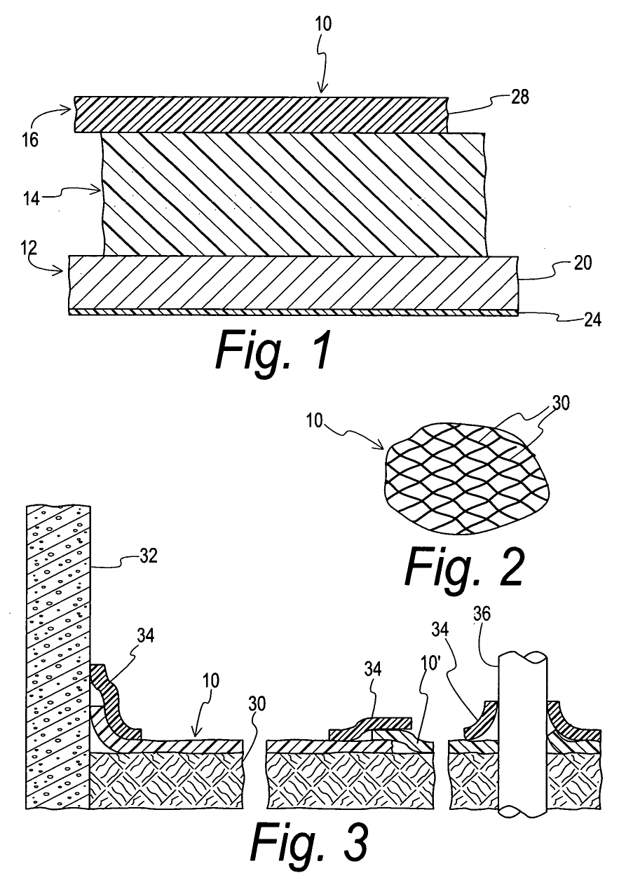

### DETAILED DESCRIPTION OF THE INVENTION

A vapor barrier sheet 10 is formed of several different generally planar sheet-like components 12, 14, and 16 that are overlaid or sandwiched and secured together to form the composite sheet 10.

One outer planar sheet component 12 is comprised of aluminum foil 20, with one face being coated with a thin film 24 of polyethylene or similar PVC. The cured film coating 24 on the foil significantly reinforces the foil against tearing or ripping, and without materially reducing the foil flexibility.

The other outer planar component 16 can be a thin sheet 28 of plastic, possibly reinforced by intersecting integral plastic formations or filaments 30, that can be arranged in a precise manner such as by meeting or crossing at specific angles, and/or with more random contact orientations.

The middle planar component 14 can be a foamed plastic sheet, only being much thicker than either of the other planar components 12, 16.

The two outer planar sheet components 12, 16 are bonded to the opposite faces of the foamed middle sheet component 14 in forming the vapor barrier sheet 10. One manner of bonding such components might be by laminating them together between compression rollers (not shown), using both local pressures (possibly 100-1000 psi) and elevated temperatures (possibly between 250-1000 degrees F. Adhesive could also be used to hold the sheets overlaid and secured together.

Thus, the planar sheet sections 12, 14 and 16 are sandwiched fixedly together, with one outer sheet section being of aluminum foil having a thin film of polyethylene on it outer face, with the other outer sheet section being of plastic having reinforcing filaments thereon, and with the thicker middle sheet section being of a foamed plastic.

More specifically, each of the outer planar sheet sections might be between 0.005″-0.05″ thick, while the middle planar sheet section might be between 0.01″-0.10″ thick. Also, the film of polyethylene on the outer face of the one outer sheet section might be between 0.0005″-0.005″ thick.

Of significance, the separated thin outer layers sandwiching the thicker middle layer appreciably strengthens the composite vapor barrier sheet 10, although the sheet is still lightweight and flexible, and can be easily shaped around or over corners. The cured coating 24 of the foil preferably could be located on one outside face of the composite sheet. The sheet vapor barrier might have an overall thickness possibly between 0.01″-0.10″.

The different composite sheet layers can be sandwiched together in the manner noted, in varying widths and lengths, including widths of possibly 6 to 12 feet and lengths of 50, 100 or even more feet, which could then stored on rolls (not shown).

Nonetheless, the composite barrier sheet 10 could be laid flat over the crawl space floor 30 to be covered as needed. When covering a floor area larger than a single composite barrier sheet, second barrier sheets 10′ could have its edge overlap by an inch or so the edge of a barrier sheet 10 already on the floor, and tape 34 can overlie and secure the overlapped edges together. When covering a crawl space floor, the sheet edge could be folded approximately 90 degrees up from the floor to lie with an inch or so flush against the foundation wall 32, suited then to be taped to the wall.

Support posts 36 might also rise up from the crawl space floor, and the separate composite sheets might have edge cutouts for receiving the posts, and tape 34 can be used for closing any gaps between the sheet and post.

What is claimed is:

1. A vapor barrier comprising three thin planar sheet sections overlaid and sandwiched together, comprising
one outer sheet section being of aluminum foil;
the other outer sheet section being of plastic;
the middle sheet section being of a foamed plastic; and
the respective outer planar sheet sections being bonded to the opposite faces of the middle sheet section.

2. A vapor barrier according to claim 1, further comprising the outer planar sheet sections each being between 0.005″-0.05″ thick, and the middle planar sheet sections being between 0.01″-0.10″ thick.

3. A vapor barrier according to claim 1, further comprising a thin film of polyethylene on the outer face of the foil outer sheet section.

4. A vapor barrier according to claim 3, further comprising said film being between 0.0005″-0.005″ thick.

5. A vapor barrier according to claim 1, further comprising each outer planar sheet sections being between 0.005″-0.05″ thick, the middle planar sheet sections being between 0.01″-0.10″ thick, and the outer planar sheet sections being bonded to the opposite faces of the middle sheet section.

6. A vapor barrier according to claim 5, further comprising a film of polyethylene on the outer face of one outer sheet section, said film being between 0.0005″-0.005″ thick.
